(19) United States
(12) Patent Application Publication
(10) Pub. No.: US 2026/0233620 A1
(43) Pub. Date: Aug. 13, 2026

(54) METHOD FOR MANAGING AN ENGINE OF A VEHICLE TO AVOID OVER-ACCELERATION

(71) Applicant: Schaeffler Technologies AG & Co. KG, Herzogenaurach (DE)

(72) Inventors: Romain GUIENNE, Toulouse (FR); Jean-Luc BOYER, Toulouse (FR)

(21) Appl. No.: 19/155,680

(22) PCT Filed: Mar. 1, 2024
(86) PCT No.: PCT/EP2024/055329

§ 371 Date: Aug. 12, 2025

(30) Foreign Application Priority Data
Mar. 8, 2023 (FR) FR2302147

(51) Int. Cl. B60L 15/20

(52) U.S. Cl. CPC B60L 15/20; B60L 2240/423

(57) ABSTRACT

A method for managing a motorized vehicle comprising:
control means;
first electronic means determining a torque demand to be supplied by the motor and supplying a corresponding signal (TQ_spt) as output; and
second electronic means for controlling the first electronic means;
   receiving data determined by the first electronic means;
   computing the torque to be supplied by the motor; and
   transmitting instructions to the first electronic means, with the following steps:
derivation of the torque demand (TQ_mod) determined by the first electronic means;
derivation of the torque (TQ_req) to be supplied by the motor computed by the second electronic means;
determining the difference between the two derivations;
comparing with a predetermined limit value (JK_lim) and adapting the torque to be supplied (TQ_spt) so that the computed difference drops below said limit value.

The present disclosure relates to a method for managing a motor of a vehicle in order to prevent an over-acceleration, and relates to such a vehicle. More specifically, it relates to electric motors, as well as to vehicles powered by an electric motor (two-wheelers such as a motorbike, a car, a four-wheeled all-terrain vehicle (also called “quad”), etc.).

### TECHNICAL FIELD

The technical field of the present invention is thus the field of motor control, more specifically for electric motors, but also for other motors such as internal combustion engines. To ensure that the motor operates correctly and notably complies with safety standards, various motor operating parameters need to be controlled, such as the vehicle speed, the torque supplied by the motor, etc.

### PRIOR ART

A motor management system can activate or deactivate a limp-home operating mode if an anomaly appears or disappears, respectively. In most cases, the limp-home operating mode involves limiting the speed of the vehicle and/or limiting the torque supplied by the motor.

In an internal combustion engine, the reaction times are relatively long and a variation in torque is therefore relatively slow in generating an accident risk. However, with an electric motor, acceleration variations can cause the vehicle to jerk, both when the limp-home mode is activated and when it is deactivated. Due to mechanical inertia, the driver of the vehicle will be more sensitive to this jerking the lower the mass of the vehicle. Accordingly, the following disclosure is primarily, but by no means exclusively, intended for light electric vehicles, such as electric motorbikes.

By way of a purely illustrative and non-limiting example, when a motorbike is cold-started, its battery can reach a low charge level corresponding to a failure limit. As a result, the motor management system will limit the maximum speed of the motorbike and/or limit the torque supplied by the motor. If the driver wishes to go faster than the imposed limit or even accelerate harder than the torque limit allows, they will tend to act on the acceleration control beyond the limit(s) imposed by the motor management system. If at this point, for example, after a running period, the battery charge level rises above the low limit, the management system switches the motor from the limp-home operating mode to its normal operating mode. Due to the position of the acceleration control, the motorbike will therefore accelerate suddenly, which does not match the expectation of the driver, who is then surprised by this sudden acceleration.

The present disclosure is based on the original observation that, when switching from operating in normal mode to operating in limp-home mode, or vice versa, driving problems can occur.

The aim of the present disclosure is to provide means for limiting, and preferably eliminating, any risk of jerking for a vehicle when transitioning from operating in limp-home mode to operating in normal mode, and/or vice versa.

### SUMMARY

According to the present disclosure, a method for managing a motor of a vehicle is proposed, said vehicle comprising:
means for controlling said motor by a driver;
first electronic means receiving a signal as input representing an action on said control means and/or signals received from sensors, determining a torque demand to be supplied by the motor based on these signals, and supplying a torque control signal to the motor as output; and
second electronic means for controlling the first electronic means;
   receiving the aforementioned signals as input that are received as input by the first electronic means, as well as data determined by the first electronic means;
   computing the torque to be supplied by the motor; and
   transmitting instructions to the first electronic means for optionally adapting the torque demand determined by the first electronic means so that the torque control signal output from the first electronic means corresponds to said torque to be supplied by the motor; said method comprising the following steps:
computing a first over-acceleration corresponding to a variation over time of the torque demand determined by the first electronic means;
computing a second over-acceleration corresponding to a variation over time of the torque to be supplied by the motor computed by the second electronic means;
determining the difference between the value of the first over-acceleration and the value of the second over-acceleration;
comparing said difference with a predetermined limit value and, if this difference in terms of absolute value is less than said limit value, the torque control instructions from the second electronic means to the first electronic means are maintained and, otherwise, they are modified so that the computed difference becomes less in terms of absolute value than said limit value.

Such a method in a novel manner proposes analyzing a curve derived from a torque curve and thus allows any variations in torque, and therefore in the corresponding acceleration of the vehicle, to be limited. Jolting and other jerking in the vehicle thus can be avoided.

In a method as described above, the features disclosed in the following paragraphs optionally can be implemented, independently of one another or in combination with one another:
when the torque control instructions are modified, they are modified such that the torque control comprises a linear torque variation range that is less than a maximum variation;
said method is implemented during a transition from operating in normal mode to operating in limp-home mode, and/or vice versa.

According to another aspect, a computer program is proposed comprising instructions for implementing a method as described above when this program is executed by a processor, notably an electronic control unit of an internal combustion engine.

According to another aspect, a computer-readable non-volatile storage medium is proposed on which such a program is stored.

According to another aspect, an electronic system for managing a motor is proposed, configured to implement all the steps of a method described above, and comprising:
a position sensor for a component for controlling a vehicle;
a computer provided with an electronic memory, configured for:
   receiving data as input that is supplied by the position sensor and/or data supplied by other sensors;
   supplying instructions for implementing the steps of a method as described above; and
   sending instructions corresponding to a torque value to be supplied by a motor.

According to another aspect, a motor vehicle is proposed, characterized in that it comprises an electronic system according to the preceding paragraph. Such a vehicle includes, for example, an electric motor, which may or may not be combined with another motor.

### BRIEF DESCRIPTION OF THE DRAWINGS

Further features, details and advantages will become apparent upon reading the following detailed description, and with reference to the appended drawings, in which:

FIG. 1 is a schematic representation of a control unit architecture of the prior art;

FIG. 2 is a schematic representation illustrating the action proposed by the present disclosure on an architecture of the type illustrated in FIG. 1;

FIG. 3 is a graphical representation explaining a method according to the present disclosure;

FIG. 4 is a set of curves illustrating the variation of various parameters during an example of implementing a method according to the present disclosure;

FIG. 5 is a schematic view of a vehicle for implementing the present disclosure.

### DESCRIPTION OF THE EMBODIMENTS

The present description is provided in relation to any motor-driven vehicle. It can be, for example, a motor vehicle, a motorbike, or a four-wheeled recreational vehicle (also called “quad”). The motor is, for example, but not exclusively, an electric motor. The vehicle can have a hybrid architecture (with, for example, an internal combustion engine and at least one electric motor).

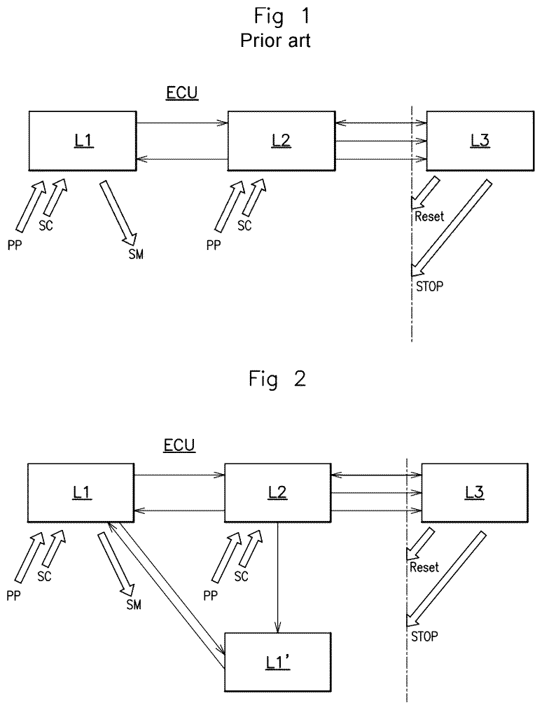

Conventionally, such a vehicle has at least one electronic management unit. More specifically, an electronic unit is intended to manage the one or more motors. FIG. 1 shows a known structure of means for managing a motor in a vehicle.

In FIG. 1, the vertical mixed line symbolizes the boundary of an electronic control and management unit (ECU) or computer, with said unit being located to the left of this mixed line and comprising first electronic means forming a first module L1 corresponding to a first control and management level and second electronic means forming a second module L2 corresponding to a second control and management level.

The first module L1 of the first level is a module designed to manage the motor, while the second module L2 of the second level, for safety reasons, is designed to control the actions/instructions provided by the first module L1. Thus, the first module L1 receives, for example, various information SC originating from several sensors (incoming arrows), one of which notably corresponds to instructions a driver sends to the motor concerning the torque to be supplied by said motor. In most cases, the control means the driver acts on are an accelerator pedal and the information supplied to the first module L1 corresponds to the pedal position (PP) of this accelerator pedal, which represents the torque demanded by the driver.

Other information SC from various sensors (pressure, temperature, etc.) are other inputs for the first module L1. Finally, after controlling with the second module L2, it is the first module L1 that will output a control signal SM to the motor.

The second module L2 controls by receiving, on the one hand, information (not necessarily all the information) received by the first module L1, notably including the position PP of the accelerator pedal (or equivalent: throttle, for example, on a two-wheeler). It also receives data from the first module L1, more specifically the data to be controlled. In return, the first module L1 receives, from the second module L2, a confirmation of the data supplied by the first module L1 and/or instructions such as, for example, to switch to a limp-home operating mode, to return to normal operating mode, etc. Several limp-home operating modes can exist: for example, a mode limiting the speed of the vehicle or even a mode limiting the torque supplied by the motor.

External control is also provided, thus providing a third control and management level. Third electronic means forming a third electronic module L3 physically disposed outside the electronic control and management unit (ECU) control the operation of the first module L1 and the second module L2. For this control, the third module L3 of the third level exchanges data with the second module L2. The second module L2 can ask the third module L3 to stop the motor or even to reset the ECU. This motor stop (STOP) and/or a reset of the electronic control and management unit (ECU) are controlled by the third module L3, if necessary. This third module L3 of the third level thus controls the operations of the second module L2 of the second level and the correct operation (memory and computer) of the first module L1 of the first level.

Such an overall architecture is known to a person skilled in the art and can have variants depending on the manufacturer, but in most cases, for safety reasons, there are two levels of control in relation to a first module L1 that receives information and/or instructions and processes them in order to send instructions, for example, a torque value to be supplied, to the motor associated with said module.

FIG. 2 shows the elements of FIG. 1 that retain the same function. The addition of a module L1′ should be noted in this case, which module is schematically illustrated as a separate module in order to better explain the interactions proposed by the present description but which can be physically integrated into the second module L2. The module L1′ in this case can be considered to be a software element disposed between the first module L1 and the second module L2, and not a separate hardware element.

In a completely original manner, the present disclosure proposes controlling any variations in acceleration in order to prevent the vehicle from jerking while running or, in other words, from shaking or jolting.

The illustrative diagram of FIG. 2 proposes that the second module L2 sends the module L1′ the torque curve that it proposes for controlling the motor. From this torque curve, the module L1′ will determine a first over-acceleration (jerk) curve corresponding to the derivative of the torque curve.

At the same time as determining an over-acceleration, the module L1′ will determine a second over-acceleration curve corresponding to the derivative of a torque curve defined by the first module L1 on the basis of instructions (PP) supplied by the driver.

The idea is to then compare the instructions received from the driver by their action on the control means (accelerator pedal, twist grip, control lever, etc.) and the instructions that the second module L2 has validated or modified in order to send them via the first module L1 to the motor and to see if these instructions correspond or if they are “significantly different” from each other. In this case, the comparison is not made on torque curves but on over-acceleration curves, i.e., curves derived from the considered torque curves. If the variation is too great, i.e., exceeds predetermined values, then the torque curve supplied by the second module L2 is adapted by the module L1′ so that the motor is controlled smoothly, without jerking or jolting.

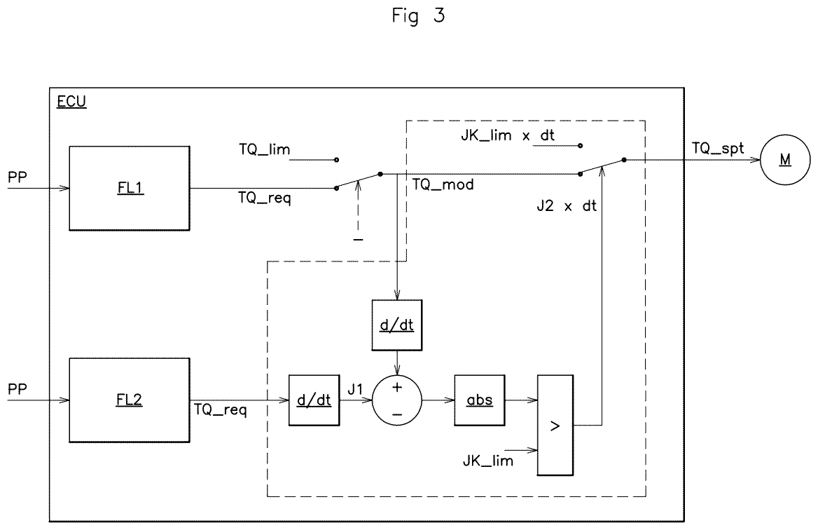

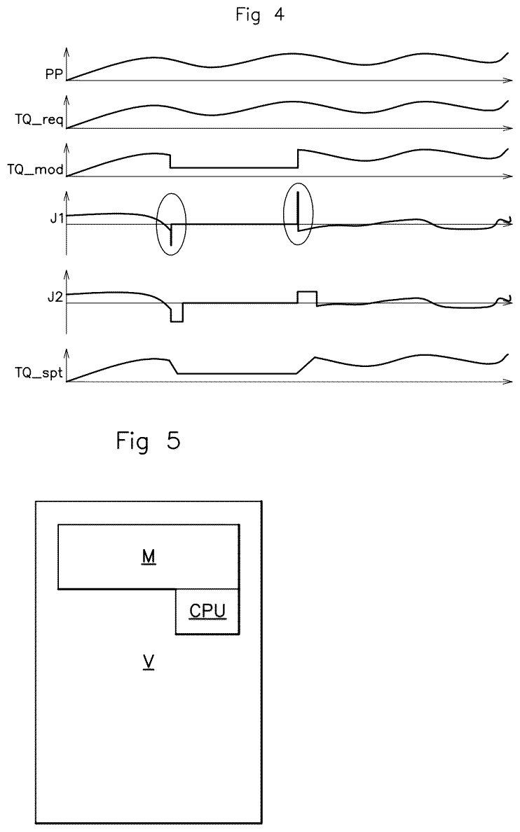

This Method Is Shown in Greater Detail in FIGS. 3 and 4.

FIG. 3 shows a “box” with as input instructions (PP) provided by a driver and as output a torque (TQ_spt) to be supplied by a motor. A sub-set is identified inside said box: it corresponds to a proposed contribution of the present disclosure with respect to a management system known in the prior art.

On the basis of instructions (PP) corresponding, for example, to a position of an accelerator pedal, a first level (software) function FL1 will determine a demanded torque curve that corresponds in terms of torque to the demand of the driver when said driver acts on the accelerator pedal (it is assumed hereafter that the control means available to the driver are an accelerator pedal, but any other means operates in a similar manner). If, for various reasons, a limp-home operating mode has to be adopted for the motor, the curve corresponding to the torque setpoint should be modified. This then results in a modified torque curve TQ_mod, which corresponds, for example, to the demanded torque curve but for which, during an operating period, the torque will be limited to a value TQ_lim.

A second level (software) function FL2 based on the same data PP also computes a corresponding torque curve.

The present disclosure proposes deriving (operation d/dt) the modified torque curve TQ_mod and the demanded torque curve TQ_req over time (computed by the function FL2). The results obtained by these two derivation operations are introduced into a comparator (+/−), which provides a difference whose absolute value abs is considered. This absolute value is compared with a predefined value JK_lim. These operations are schematically shown in FIG. 3, in a region surrounded by a dashed line. If said absolute value abs remains below JK_lim, then the modified torque curve TQ_mod, which can correspond to the demanded torque curve computed by the function FL2, is validated and becomes the torque curve TQ_spt that then corresponds to the torque instructions supplied to the motor. However, if the absolute value abs exceeds the value JK_lim, then the instructions torque curve TQ_mod provided by the function FL1 is modified so that the torque variations of this curve are attenuated.

FIG. 4 illustrates the method described above with illustrative curves.

The first curve PP shows the variations in position of an accelerator pedal. By depressing an accelerator pedal, a driver provides the motor of the vehicle with instructions to indicate whether they want the vehicle to go faster or slower. In this way, they manage the acceleration of the vehicle. This is correlated with the torque transferred to the wheels of the vehicle. This torque substantially corresponds to the torque supplied by the one or more motors to the nearest transmission ratio (in this case, it is also possible to include the efficiency of the transmission, which is always less than 1). Thus, it can be seen that the motor torque is linked to the acceleration of the vehicle and the present disclosure proposes working from a motor torque because this is the quantity usually used to manage a motor, but in theory another torque quantity, torque at the wheel, for example, or acceleration of the vehicle, also could be considered.

The curve Tq_req corresponds to translating the action of the driver on the accelerator pedal into torque. In order for the vehicle to accelerate as illustrated by the curve PP providing the position of the accelerator pedal, the motor considered to move the vehicle must supply a torque according to the illustrated demanded torque curve TQ_req.

The modified torque curve TQ_mod assumes that, for a period of time, the function FL1 has determined that the motor should operate in a limp-home mode and that the torque supplied by the motor cannot exceed a value TQ_lim (as shown in FIG. 3).

The curves derived from TQ_req and TQ_mod are computed. The curve derived from TQ_req is not illustrated, but it can be seen from the curve Tq_req that torque variations are limited and are very gradual. The over-acceleration (i.e., the derivative of the acceleration, or in this case of the torque that is considered to be an equivalent value) is virtually zero.

The curve J1 for its part illustrates the variation of the modified torque TQ_mod. It can be seen in this case that the over-acceleration provided by J1 has a significant negative value corresponding to limiting the torque to the torque TQ_lim and then has a significant positive value because the torque demand suddenly changes from the value Tq_lim to a higher torque value.

The over-acceleration curve J1 is then modified to the curve J2. As the curve Tq_mod corresponds to the curve Tq_req, with torque locally limited to TQ_lim, the curve J2 corresponds, for example, to the curve J1 for which the value of the over-acceleration is limited to a value JK_lim. The peaks of J1 are thus replaced by steps in terms of absolute value JK_lim or even preferably a value less than JK_lim, for example, JK_lim*0.9 or even JK_lim*0.5.

By then integrating the curve J2, the torque curve TQ_spt to be supplied is obtained that is determined by the module L1′, supplied to the first module L1, which accordingly transmits torque instructions to the motor via the signal SM. It should be noted that, when the value of the over-acceleration is capped at a limit value (JK_lim or a proportion of this limit), the value of the torque progresses linearly, and therefore the acceleration of the vehicle is progressive, without jolting or jerking.

The method described above is preferably implemented by an electronic unit on-board a vehicle, for example, a motor vehicle. This electronic unit corresponds to the electronic control and management unit ECU, also known as CPU. FIG. 5 schematically illustrates a vehicle V powered by a motor M, with said motor being electronically controlled by at least one electronic unit CPU. The motor M is an electric motor, for example.

### INDUSTRIAL APPLICATION

The present technical solution notably can be applied to motor control. It is more specifically intended for controlling one or more electric motors, which may or may not be linked to a combustion engine, but it also can be more generally contemplated for controlling any motor. Indeed, compared to an electric motor, any torque variations in an internal combustion engine are slower due to the inertia of an internal combustion engine when modifying its torque.

In a completely original way, the aim herein is to control an over-acceleration. This allows the driving comfort of a vehicle to be improved. This improvement is even more noticeable when the vehicle is light. Indeed, the mass of the vehicle increases its inertia and variations in acceleration are partially “absorbed” by the mass of the vehicle.

As explained in the present disclosure, the additional control introduced herein does not require the presence of a new sensor and can be carried out by software, without modifying the structure of the electronic control and management unit.

The present disclosure is not limited to the proposed embodiments and to the alternative embodiments described above, which are provided solely by way of examples, but it encompasses all the alternative embodiments that could be contemplated by a person skilled in the art within the scope of the intended protection.

1. A method for managing a motor of a vehicle, said vehicle comprising:
means for controlling said motor by a driver;
first electronic means (L1) receiving a signal (PP) as input representing an action on said control means and/or signals (SC) received from sensors, determining a torque demand (TQ_req) to be supplied by the motor based on these signals, and supplying a torque control signal (TQ_spt) to the motor as output; and
second electronic means (L2) for controlling the first electronic means (L1);
receiving the aforementioned signals (PP) as input that are received as input by the first electronic means (L1), as well as data determined by the first electronic means (L1);
computing the torque to be supplied by the motor (TQ_mod), with a torque limited to a value TQ_lim during the operation of the motor in limp-home mode; and
transmitting instructions to the first electronic means (L1) for optionally adapting the torque demand determined by the first electronic means (L1) so that the torque control signal (TQ_spt) output from the first electronic means (L1) corresponds to said torque to be supplied by the motor (TQ_mod);
said method comprising the following steps: [symbol]
computing a first over-acceleration corresponding to a variation over time of the torque demand (TQ_req) determined by the first electronic means (L1);
computing a second over-acceleration corresponding to a variation over time of the torque to be supplied by the motor (TQ_mod) computed by the second electronic means (L2);
determining the difference between the value of the first over-acceleration and the value of the second over-acceleration;
comparing said difference with a predetermined limit value (JK_lim) and, if this difference in terms of absolute value is less than said limit value, the torque control instructions from the second electronic means to the first electronic means are maintained and, otherwise, they are modified so that the computed difference becomes less in terms of absolute value than said limit value.

2. The method as claimed in claim 1, characterized in that when the torque control instructions are modified, they are modified such that the torque control (TQ_spt) comprises a linear torque variation range that is less than a maximum variation.

3. The method as claimed in characterized in that it is implemented during a transition from operating in normal mode to operating in limp-home mode, and/or vice versa.

4. An electronic system for managing a motor, configured to implement all the steps of a method as claimed in claim 1, and comprising:
a position sensor for a component for controlling a vehicle;
a computer (ECU) provided with an electronic memory, configured for:
receiving data (PP) as input that is supplied by the position sensor and/or data that is supplied by other sensors;
supplying instructions for implementing the steps of a method as claimed in claim 1; and
sending instructions corresponding to a torque value (TQ_spt) to be supplied by a motor.

5. A computer program comprising instructions which, when the program is executed by a computer, cause the computer to implement all the steps of a method as claimed in claim 1.

6. A non-transitory computer-readable recording medium, characterized in that a computer program as claimed in claim 5 is stored on said medium.

7. A vehicle, characterized in that it comprises an electronic system as claimed in claim 5.

8. A vehicle as claimed in claim 6, characterized in that it comprises at least one electric motor.
